(19) United States
(12) Patent Application Publication
(10) Pub. No.: US 2005/0163351 A1
(43) Pub. Date: Jul. 28, 2005

(54) Semiconductor fingerprint sensing apparatus with shielding unit

(75) Inventors: Won-Chan Kim, Seoul (KR); Dong-Jin Min, Seoul (KR)

Correspondence Address: BACON & THOMAS, PLLC, 625 SLATERS LANE, FOURTH FLOOR, ALEXANDRIA, VA, 22314, US

(73) Assignee: MELFAS CO LTD, Seoul (KR)

(21) Appl. No.: 10/506,245

(22) PCT Filed: Jun. 12, 2002
(86) PCT No.: PCT/KR02/01111

(30) Foreign Application Priority Data
Mar. 9, 2002 (KR) 200212757

(51) Int. Cl. G06K 9/00

(52) U.S. Cl. 382/124

(57) ABSTRACT

Disclosed is a semiconductor fingerprint sensing apparatus with a shielding unit for sensing an inherent pattern of a fingerprint by using minute difference of fingerprint impedance. This fingerprint sensing apparatus has the shielding unit between a charge supplying unit and a sensing electrode to prevent DC current from being directly applied to the human body through the sensing electrode. The fingerprint sensing apparatus also has a discharging unit for compulsorily discharging charges residual in the shielding unit and the sensing electrode, so the sensing electrode may be always charged at a regular level.

### TECHNICAL FIELD

The present invention relates to a semiconductor fingerprint sensor for detecting an inherent pattern of a fingerprint by use of minute difference of fingerprint impedances according to the shape of valleys and ridges of the fingerprint. In particular, the present invention relates to a fingerprint signal generating circuit applied to the semiconductor fingerprint sensor.

### BACKGROUND ART

The fingerprint sensing and matching technique is reliable for personal identification or verification, and used in various fields. A fingerprint sensing method currently used in the fingerprint identification system may be classified into an optical way and a semiconductor way, in broad.

The optical fingerprint sensor uses an image processing system which scans rays to a fingerprint, extracts an inherent characteristic of the fingerprint and then compares it with well-known reference fingerprint characteristics. This image processing system generally has an optical sensor for converting the fingerprint information into digital waveforms. In addition, the image processing system requires an optical device, for example a laser source, a condenser and so on.

Conventionally, there have been published many patents disclosing such an optical fingerprint sensor. For example, U.S. Pat. No. 4,210,899 discloses an optic scanning fingerprint reader associated with a central processing station for the purpose of the usage in security access applications which, for example, allow the approach of a person to a certain location or allow the access to a computer terminal.

U.S. Pat. No. 4,525,859 also discloses a video camera for determining whether a fingerprint is matched with an existing fingerprint database by use of details of the fingerprint, i.e., branches and terminations of the fingerprint ridges.

In addition, U.S. Pat. No. 4,582,985 discloses a fingerprint verification system made in an approximate size of a common credit card.

The semiconductor fingerprint sensor uses the difference of electrical characteristics according to the shape of valley and ridge of the fingerprint. When the fingerprint is contacted with the sensor, the fingerprint sensor senses electric signals induced by the electric characteristic of the fingerprint to extract the fingerprint pattern..

In case of the semiconductor fingerprint sensor, most components may be loaded on a semiconductor wafer, and easily made in a small size. The semiconductor fingerprint sensor in these days has a size as small as a coin, which is easily mounted to portable or small devices. In addition, since this sensor uses characteristics of the actual fingerprint, a picture or a mold of the fingerprint may not be possibly recognized, thereby ensuring the security system having higher security level than the optical one.

However, the semiconductor fingerprint sensor may have a weak durability since it should be directly contacted with fingerprints.

FIG. 1 is a schematic functional diagram showing a general semiconductor fingerprint sensing apparatus.

Generally, the semiconductor fingerprint sensing apparatus 10 has a fingerprint signal generating unit 20 for generating an analogue fingerprint signal (V_{SP}) expressing electric characteristics inherent to a fingerprint impedance according to the shape of valleys and ridges of the fingerprint, a signal converter 30 for converting this analogue fingerprint signal (V_{SP}) into a digital signal, and a signal processing unit 40 for regularly processing the fingerprint signal in order to detect or determine an inherent pattern of the fingerprint An example of such a semiconductor fingerprint sensing apparatus is disclosed in U.S. Pat. No. 6,052,475 issued to Eric L. Upton in the title of “fingerprint detector using ridge resistance sensing array”.

In addition, this inventor has also developed a semiconductor sensing apparatus for generating an analogue fingerprint signal reflecting the charging/discharging characteristic of the fingerprint impedance, counting and digitalizing the time required for this analogue signal to reach a reference level, and then detecting an inherent pattern of the fingerprint from this digital count value.

The fingerprint signal generating unit applied to the fingerprint sensing apparatus 10 developed by the inventor is configured as shown in FIG. 2.

This fingerprint signal generating unit 20 generates successive analogue fingerprint signals which reflect fingerprint impedances at each sensing point according to the fingerprint characteristics.

In other words, if a fingerprint to be detected is contacted on the sensing electrodes arranged in matrix, the fingerprint signal generating unit 20 generates an analogue fingerprint signal (V_{SP}) expressing the charging/discharging characteristics of the fingerprint impedance by supplying or discharging charges to/from the fingerprint impedance formed between the fingerprint and the sensing electrode.

This fingerprint signal generating unit 20 is also composed of a sensing electrode 21, a fingerprint impedance 22, a parasitic impedance 23 and a charge supplying unit 24.

The sensing electrode 21 is directly contacted with the skin on which the fingerprint to be detected is formed. There are arranged a plurality of sensing electrodes 21 on the surface of the fingerprint sensor in matrix as shown in FIG. 3a.

The fingerprint impedance 22 is formed between the sensing electrode 21 and the valley or ridge of the fingerprint when the fingerprint is contacted with the sensing electrode 21, as shown in FIG. 3a. This fingerprint impedance 22 includes a resistance component (R_{F}) and a capacitance component (C_{F}), as shown in FIG. 3b. In case of the fingerprint impedance, the difference of the resistances is generally great between the valley and the ridge of the fingerprint.

The parasitic impedance 23 is an inherent impedance of the sensing apparatus itself which is formed between the sensing electrode 21 and a ground terminal (GND) when the fingerprint is not contacted with the sensing electrode 21. This parasitic impedance 23 includes a parasitic capacitance significantly greater than the capacitance of the fingerprint impedance 22. Thus, the parasitic capacitance having a greater value than the capacitance of the fingerprint impedance becomes a main capacitance component of the sensing impedance (Z_{S}; Z_{S}=Z_{F}+Z_{P}).

On the other hand, the parasitic resistance has a very small value rather than the resistance of the fingerprint impedance 22, so the resistance of the fingerprint impedance 22 becomes a main resistance component of the sensing impedance (Z_{S}; Z_{S}=Z_{F}+Z_{P}).

The charge supplying unit 24 plays a role of charging or discharging the impedance formed between the sensing electrode and the ground terminal by applying charges or cutting off the supply of charges to the sensing electrode while the fingerprint is contacted with the sensing electrode.

In case of FIG. 2, a voltage source (V_{DD}) is adopted as the charge supplying unit, and a digital switching element such as a tri-state buffer 24 is used to control the operation of this voltage source (V_{DD}).

The voltage source (V_{DD}) may supply both a constant fixed voltage or a variable voltage.

The tri-state buffer 24 connects the voltage source to the sensing electrode 21 and supplies charges to the fingerprint impedance 22 when “ON” signal is applied to the enable terminal (EN), while it quits the supply of charges by cutting off the connection between the voltage source and the sensing electrode 21 when “OFF” signal is applied to the enable terminal (EN).

As described above, in case the charges are directly applied to the fingerprint while the fingerprint is contacted with the sensing electrodes 21, the finger and human body become directly exposed to DC current. Thus, a large amount of current flows through the human body at once from hundreds or thousands of sensing electrodes, which may be harmful to the human body. In addition, this causes great energy consumption through the sensing electrodes during the initial charging process.

### DISCLOSURE OF INVENTION

The present invention is designed to solve the problems of the prior art, and therefore an object of the invention is to provide an fingerprint sensing apparatus which is capable of preventing DC current from being directly applied between the finger (or, fingerprint) and a sensing electrode of a fingerprint sensor.

In this reason, the fingerprint sensing apparatus includes a shielding unit between a charge supplying unit and a sensing electrode for shielding the direct movement of DC current.

However, if the shielding unit is positioned between the charge supplying unit and the sensing electrode, there may be aroused additional problems.

In other words, the charges applied from the charge supplying unit due to the voltages at both ends of the shielding unit may be not transferred to the sensing electrode or the charges accumulated in the sensing electrode may be not discharged and remain, which causes residual charges in the sensing electrode.

Thus, in order to solve the problem resulted from the adoption of the shielding unit, the present invention further uses an initiating unit for setting identical initial conditions in the sensing electrodes and/or at both ends of the shielding unit.

In order to accomplish the above object, the fingerprint sensing apparatus of the present invention includes a plurality of sensing electrodes arranged in matrix for contacting with a fingertip (or, ridges and valleys of the fingerprint); a charge supplying unit for supplying charges to the sensing electrodes; and a shielding unit positioned between the sensing electrode and the charge supplying unit for preventing DC current from being directly transferred to the fingertip through the sensing electrode.

At this time, the shielding unit is preferably configured using a charge accumulating element.

Thus, it becomes possible to prevent damage of the human body caused by the direct impression of DC current and reduce energy consumption of the semiconductor fingerprint sensor by means of eliminating DC components of the electric signals generated when the fingerprint is contacted.

In another aspect of the present invention, there is also provided a fingerprint sensing apparatus, which includes a plurality of sensing electrodes arranged in matrix for contacting with a fingertip (or, ridges and valleys of the fingerprint); a charge supplying unit for supplying charges to the sensing electrodes; a shielding unit positioned between the sensing electrode and the charge supplying unit for preventing DC current from being directly transferred to the fingertip through the sensing electrode; and an initiating unit for keeping electric characteristic of the sensing electrodes uniformly in order to synchronize initial conditions for generating the fingerprint signals.

At this time, the initiating unit preferably includes a unit for intentionally eliminating residual charges existing in the sensing electrodes and/or at both ends of the shielding unit after the discharging of the sensing electrodes; and a unit for charging the sensing electrodes uniformly on the basis of the residual charges existing in the sensing electrodes after the discharging of the sensing electrodes.

In still another aspect of the present invention, there is also provided a fingerprint sensing apparatus, which includes a plurality of sensing electrodes arranged in matrix for contacting with a fingertip (or, ridges and valleys of the fingerprint); a charge supplying unit for supplying charges to the sensing electrodes; a shielding unit positioned between the sensing electrode and the charge supplying unit for preventing DC current from being directly transferred to the fingertip through the sensing electrode; and a discharging unit for intentionally discharging the residual charges existing in the sensing electrodes and/or at both ends of the shielding unit in order to charge the sensing electrodes uniformly.

At this time, the discharging unit may include a discharging path for discharging the residual charges existing in the sensing electrodes and/or at both ends of the shielding unit to a ground point; and a switching element installed on the discharging path to switch on/off.

In further another aspect of the present invention, there is also provided a fingerprint sensing apparatus, which includes a plurality of sensing electrodes arranged in matrix for contacting with a fingertip (or, ridges and valleys of the fingerprint); a charge supplying unit for supplying charges to the sensing electrodes; a shielding unit positioned between the sensing electrode and the charge supplying unit for preventing DC current from being directly transferred to the fingertip through the sensing electrode; a first discharging unit for intentionally discharging the residual charges existing at the sensing electrodes in order to charge the sensing electrodes uniformly; and a second discharging unit for intentionally discharging the residual charges existing at both ends of the shielding unit in order to charge the sensing electrodes uniformly.

At this time, the first discharging unit may include a first discharging path for discharging the residual charges existing in the sensing electrodes to a ground point, and a first switching element installed on the first discharging path to switch on/off; and the second discharging unit may include a second discharging path for discharging the residual charges existing at both ends of the shielding unit to a ground point, and a second switching element installed on the second discharging path to switch on/off

Thus, the residual charges may be discharged to the ground point through the first and second discharging paths by switching on the first and second switching elements at the point that the residual charges are discharged.

In still another aspect of the present invention, there is also provided a fingerprint sensing apparatus, which includes a plurality of sensing electrodes arranged in matrix for contacting with a fingertip (or, ridges and valleys of the fingerprint); a charge supplying unit for supplying charges to the sensing electrodes; a shielding unit positioned between the sensing electrode and the charge supplying unit for preventing DC current from being directly transferred to the fingertip through the sensing electrode; a unit for measuring the residual charges in the sensing electrodes; and a controller for controlling the magnitude of the current applied to the shielding unit from the voltage source in order to compare the residual charge amount with a reference charge amount and then compensate their difference.

In further another aspect of the present invention, there is also provided a fingerprint sensing apparatus, which includes a plurality of sensing electrodes arranged in matrix for contacting with a fingertip (or, ridges and valleys of the fingerprint); a charge supplying unit for supplying charges to the sensing electrodes; a shielding unit positioned between the sensing electrode and the charge supplying unit for preventing DC current from being directly transferred to the fingertip through the sensing electrode; a unit for measuring the residual charges in the sensing electrodes; and a controller for controlling the time taken for applying the current to the shielding unit from the voltage source in order to compare the residual charge amount with a reference charge amount and then compensate their difference.

### BRIEF DESCRIPTION OF THE DRAWINGS

These and other features, aspects, and advantages of preferred embodiments of the present invention will be more fully described in the following detailed description, taken accompanying drawings. In the drawings:

FIG. 1 is a schematic functional diagram showing a general fingerprint sensing apparatus;

FIG. 2 shows detailed configuration of a fingerprint signal generating unit applied to the conventional fingerprint sensing apparatus;

FIG. 3a is a sectional view showing a skin resistance sensing array, and FIG. 3b shows an equivalent circuit of a fingerprint impedance;

FIG. 4 shows configuration of a fingerprint signal generating device according to a first embodiment of the present invention;

FIG. 5a is for illustrating the charging mechanism of the fingerprint signal generating device of FIG. 4, FIG. 5b is for illustrating the discharging mechanism, and FIG. 5c is for illustrating the electric characteristics of both ends of a shielding capacitor after discharging;

FIG. 6 shows configuration of the fingerprint signal generating device according to a second embodiment of the present invention;

FIG. 7 show configuration of the fingerprint signal generating device according to a third embodiment of the present invention; and

FIG. 8 is a timing chart showing the change of fingerprint signal according to the change of supplied charges and switching signal in the fingerprint signal generating circuits of FIGS. 6 and 7.

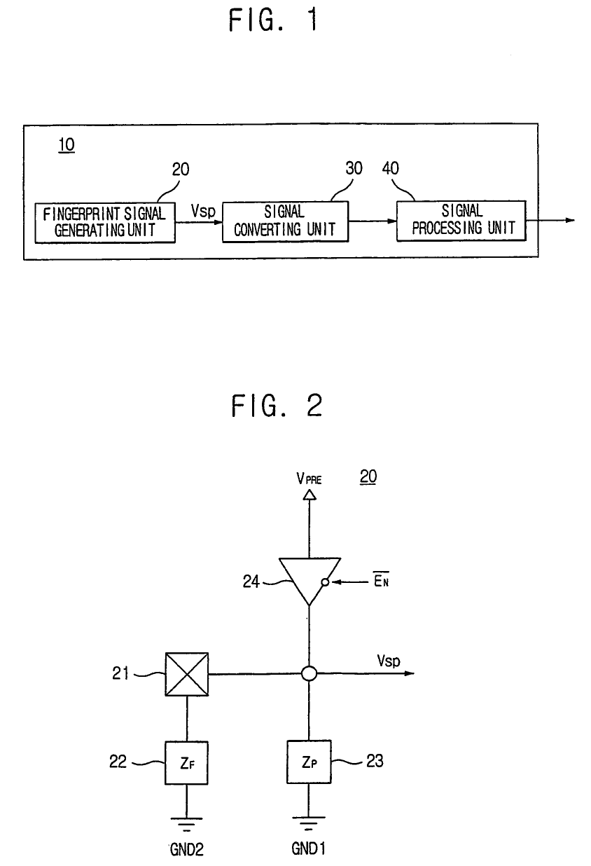

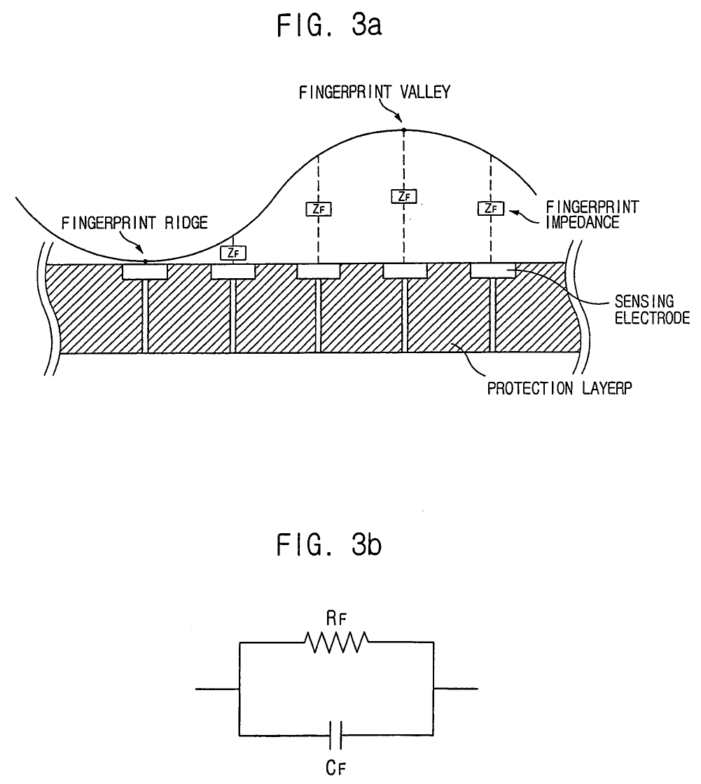

### BEST MODES FOR CARRYING OUT THE INVENTION

Hereinafter, configuration of a fingerprint sensing apparatus according to preferred embodiments of the present invention will be described in detail with reference to the accompanying drawings.

The fingerprint signal generating device 100 and 200 described below is applied to the fingerprint signal generating unit 20 of the semiconductor fingerprint sensing apparatus 10 shown in FIG. 1 to generate an analogue fingerprint signal reflecting the electric characteristics of the fingerprint impedance.

### EMBODIMENT 1

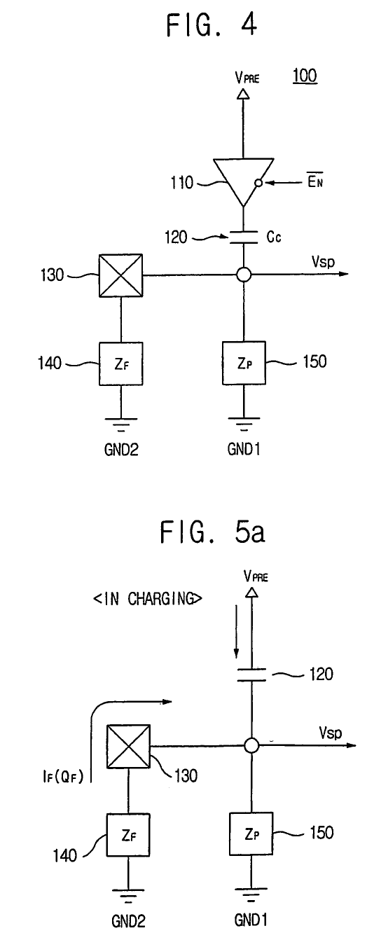

At first, a fingerprint signal generating device according to the first embodiment of the present invention is described with reference to FIG. 4.

The fingerprint signal generating device 100 of this embodiment additionally includes a shielding unit 120 between a charge supplying unit (V_{PRE}) 110 and a sensing electrode 130. If the shielding unit 120 is positioned between the tri-state buffer 110 and the sensing electrode 130, the successive supply of DC current applied to the human body through the sensing electrode 130 may be cut off.

In case of FIG. 4, though the voltage source (V_{PRE}) and the tri-state buffer 110 are exemplarily shown as the charge supplying unit, the charge supplying unit of this embodiment is not limited to the case, and other charge supplying sources such as a current source may also be used, of course.

In addition, as for the shielding unit, this embodiment adopts a capacitor which is a kind of a charge accumulating element. However, the shielding unit of this embodiment is not absolutely limited to the capacitor, other elements may also be used if they are capable of accomplishing the shielding function for preventing DC current from being directly applied to the human body.

Now, the operation of the fingerprint signal generating device of this embodiment is described with reference to FIG. 4.

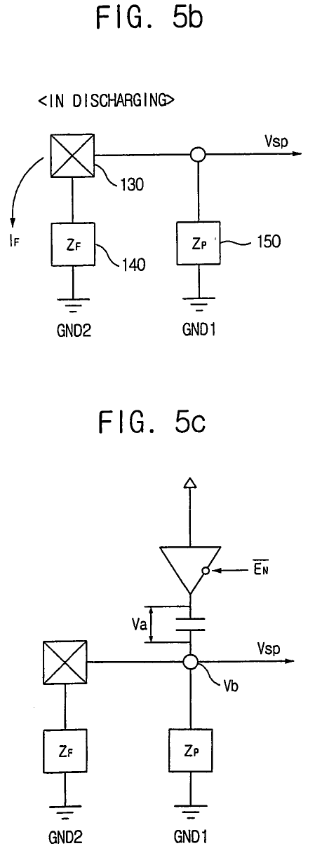

If the enable signal (EN) “ON” is applied to a gate terminal of the tri-state buffer 110, the fingerprint signal generating device 100 of FIG. 4 may be expressed as the equivalent circuit of FIG. 5a.

Due to the displacement current supplied from the voltage source (V_{PRE}), the (+) voltage of the shielding capacitor 120 increases up to a predetermined magnitude, and the (−) voltage of the capacitor 120 thereby increases in concert with the (+) voltage.

The displacement current (I_{F}) having the cathode (−) is supplied to the cathode (−) of the shielding capacitor 120 from the finger contacted with the sensing electrode 130.

This displacement current (I_{F}) having the cathode (−) is successively supplied to the shielding capacitor 120 until the (−) voltage of the shielding capacitor is synchronized with the (+) voltage, in order to initiate the voltage of the sensing electrode to a predetermined voltage level (or, to charge the sensing electrode).

On the other hand, if the enable signal “OFF” is applied to the gate terminal of the tri-state buffer, the fingerprint signal generating device 100 of FIG. 4 may be expressed as the equivalent circuit of FIG. 5b.

In other words, the charges charged in the sensing electrode 130 are discharged toward the ground point (GND2) through a fingerprint impedance 140 due to the resistance of the fingerprint impedance 140, as shown in FIG. 5b. This discharging characteristic of the sensing electrode is output out of the fingerprint signal generating device 100 as a fingerprint signal (V_{SP}). At this time, the discharging characteristic of the fingerprint signal is mainly determined based on the resistance of the fingerprint impedance.

As described above, since the DC component of the charges is not directly supplied to the human body from the voltage source or the current source owing to the shielding capacitor 120, the fingerprint signal generating device of this embodiment may be harmless to the human body and reduce the energy consumption dramatically.

However, though the shielding capacitor has an advantage that it may prevent the DC current from being directly applied to the human body, there is also accompanied the following abnormal operations.

In other words, as shown in FIG. 5c, if the charges of the sensing electrode 130 are not all discharged, the residual charges may form a certain voltage (Vₐ) at both ends of the shielding capacitor 110. This phenomenon is always aroused whenever the time difference between frames are not sufficiently ensured. Thus, the residual charges are accumulated in the sensing electrode at each frame, so the sensing electrode resultantly has different offset voltages at each frame. Accordingly, the fingerprint signal (V_{SP}) cannot form a constant voltage level, but there are formed fingerprint signals based on DC voltage caused by the residual charges, which are different at each frame. Thus, it becomes hardly possible to detect an accurate fingerprint signal.

If there exist residual charges in the sensing electrode or the shielding capacitor, it is impossible to uniformly initiate all sensing electrodes of the fingerprint sensing apparatus to always have a constant voltage level. Here, the term ‘uniform initiation’ is defined to identify electric states (or, initial voltage levels) of all sensing electrodes before the charging in the cycle which periodically repeats charging and discharging.

As described above, if the initiating state of the sensing electrodes is not uniform, the pattern of the fingerprint signal changes according to a detect point or time of the signal, which makes it difficult to detect a reliable fingerprint pattern.

In order to solve this problem, the inventors adds an initiating unit to the fingerprint signal generating device of the first embodiment. This initiating unit is used for forcibly controlling initial voltage levels of all sensing electrodes to have the same value before charging the sensing electrode for the generation of the fingerprint signal.

### EMBODIMENT 2

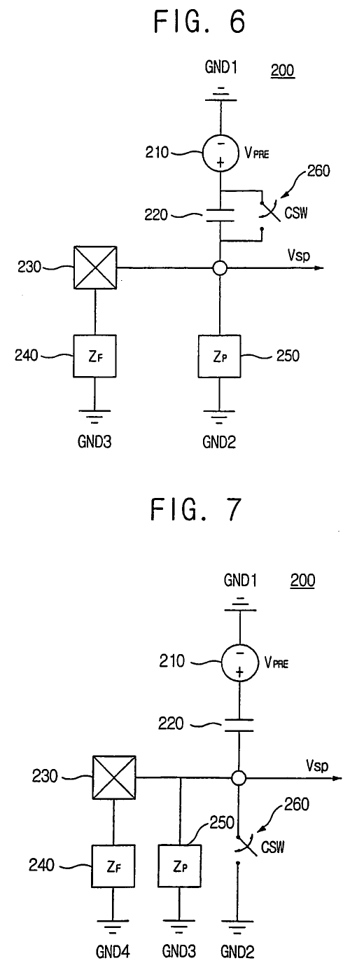

At first, FIG. 6 shows a model for discharging the residual charges existing in the sensing electrode to the ground point through discharging paths formed in parallel to the shielding unit.

As shown in FIG. 6, the fingerprint signal generating circuit 200 of this embodiment includes a charge supplying unit 210, a shielding unit 220, a sensing electrode 230, an initiating unit 260, a parasitic impedance 250 and a fingerprint impedance 240.

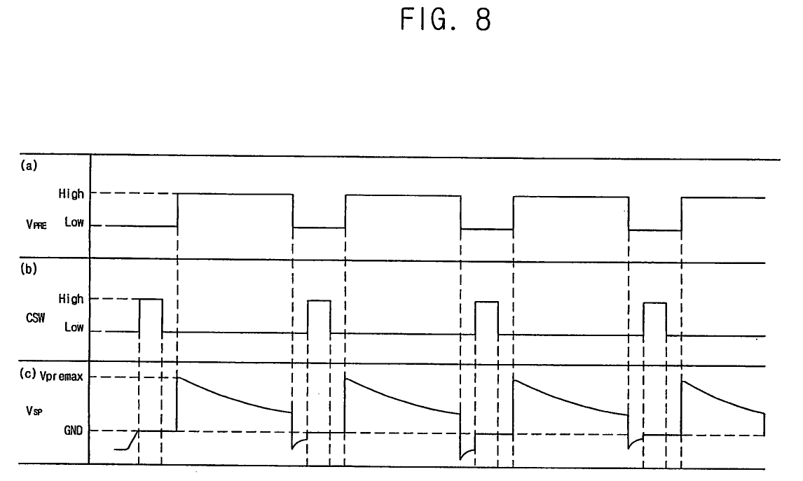

The charge supplying unit is preferably a voltage source 210 for supplying period pulse voltage as shown in FIG. 8. In addition, the shielding unit 220 is a capacitor which is a kind of a charge accumulating element, and the initiating unit 260 is configured with a path for electrically connecting both ends of the shielding capacitor 220 and a switching element installed on the path. The switching element is switched on/off according to a switching control signal (CSW) as shown in FIG. 6. This switching control signal (CSW) is applied from a controller (not shown). Thus, the path becomes a short circuit when the switching element becomes on, and the path functions as an open circuit when the switching element switches off.

The charge supplying unit and the shielding unit of the present embodiment are not limited to the voltage source and the capacitor, and various equivalents may be adopted in order to accomplish the same function and the same effects.

In addition, the sensing electrode 230, the fingerprint impedance 240 and the parasitic impedance 250 are configured identically to the first embodiment.

Now, an initiating mechanism of the fingerprint signal generating device of this embodiment is described on the basis of the above-mentioned configuration with reference to FIGS. 6 and 8.

In the state that the fingerprint is contacted with the sensing electrode 230, the switching element 260 becomes “OFF”, and the discharging path is opened. The displacement current is applied from the voltage source 210 to the anode (+) of the shielding capacitor 220, and the (−) displacement voltage is applied to the cathode (−) of the shielding capacitor 220 from the fingertip of the human body so as to be synchronized with the increase of electric potential of the anode (+). Thereby, the sensing electrode 230 is initiated (or, charged) to a predetermined voltage level (Vₚᵣₑₘₐₓ, see (a) and (c) of FIG. 8).

The charges charged in the sensing electrode 230 as above are mainly discharged through the fingerprint impedance 240. An analogue fingerprint signal (V_{SP}) reflecting the discharging characteristic of the fingerprint impedance is output outside from the fingerprint signal generating device.

After a predetermined time from the initiation of the discharging, if the voltage level of the voltage source 210 is decreased to GND1, an electric potential difference as much as Vᵣₑₛ is generated between both ends of the shielding capacitor 220. In addition, as the anode (+) of the shielding capacitor 220 is connected to GND1, the electric potential difference of the sensing electrode (at the anode (−) of the shielding capacitor) is instantly reversed to −Vᵣₑₛ.

If the switching control pulse (see (b) of FIG. 8) is applied to the switching element and the switching element switches on while the voltage of the sensing electrode 230 is reversed, the path connects the sensing electrode to the ground point GND1 via the shielding capacitor.

If the discharging path is formed between the sensing electrode and the ground point GND1 as described above, the residual charges existing in the sensing electrode are discharged to GND1 through the discharging path.

If the switching element switches off and the path is again opened, all sensing electrodes keep uniform initial state until charges are supplied again from the voltage source (see (c) of FIG. 8).

### EMBODIMENT 3

FIG. 7 shows a model for discharging the residual charges existing in, the sensing electrode to the ground point GND2 through a separate discharging path.

As shown in FIG. 7, the fingerprint signal generating circuit 200 of this embodiment includes a charge supplying unit 210, a shielding unit 220, a sensing electrode 230, an initiating unit 260, a parasitic impedance 250 and a fingerprint impedance 240.

The charge supplying unit is preferably a voltage source 210 for supplying period pulse voltage as shown in FIG. 8. In addition, the shielding unit 220 is a capacitor which is a kind of a charge accumulating element, and the initiating unit 260 is configured with a path for electrically connecting the sensing electrode to the ground point GND2 and a switching element installed on the path. The switching element is switched on/off according to a switching control signal (CSW) as shown in FIG. 6. This switching control signal (CSW) is applied from a controller (not shown). Thus, the path becomes a short circuit when the switching element becomes on, and the path functions as an open circuit when the switching element switches off.

The charge supplying unit and the shielding unit of the present embodiment are not limited to the voltage source and the capacitor, and various equivalents may be adopted in order to accomplish the same function and the same effects.

In addition, the sensing electrode 230, the fingerprint impedance 240 and the parasitic impedance 250 are configured identically to the first embodiment.

Now, an initiating mechanism of the fingerprint signal generating device of this embodiment is described on the basis of the above-mentioned configuration with reference to FIGS. 7 and 8.

In the state that the fingerprint is contacted with the sensing electrode 230, the switching element 260 becomes “OFF”, and the discharging path is opened. The displacement current is applied from the voltage source 210 to the anode (+) of the shielding capacitor 220, and the (−) displacement voltage is applied to the cathode (−) of the shielding capacitor 220 from the fingertip of the human body so as to be synchronized with the increase of electric potential of the anode (+). Thereby, the sensing electrode 230 is initiated (or, charged) to a predetermined voltage level (Vₚᵣₑₘₐₓ, see (a) and (c) of FIG. 8).

The charges charged in the sensing electrode 230 as above are mainly discharged through the fingerprint impedance 240. An analogue fingerprint signal (V_{SP}) reflecting the discharging characteristic of the fingerprint impedance is output outside from the fingerprint signal generating device.

After a predetermined time from the initiation of the discharging, if the voltage level of the voltage source 210 is decreased to GND 1, an electric potential difference as much as Vᵣₑₛ is generated between both ends of the shielding capacitor 220. In addition, as the anode (+) of the shielding capacitor 220 is connected to GND1, the electric potential difference of the sensing electrode (at the anode (−) of the shielding capacitor) is instantly reversed to −Vᵣₑₛ.

If the switching control pulse (see (b) of FIG. 8) is applied to the switching element and the switching element switches on while the voltage of the sensing electrode 230 is reversed, the path connects the sensing electrode to the ground point GND2.

If the discharging path is formed between the sensing electrode and the ground point GND2 as described above, the residual charges existing in the sensing electrode are discharged to GND2 through the discharging path.

If the switching element switches off and the path is again opened, all sensing electrodes keep uniform initial state until charges are supplied again from the voltage source (see (c) of FIG. 8).

The second and third embodiments arrange the shielding capacitor between the voltage source and the sensing electrode in order to prevent DC current from being directly supplied to the human body from the voltage source. In addition, by discharging the residual charges remained in the sensing electrode or the shielding capacitor after discharging through the ground point GND1 or GND2, it is possible to keep the initial charging level of all sensing electrodes to be always uniform.

The second and third embodiments make the initial condition of the sensing electrodes uniform by discharging the residual charges existing in the sensing electrodes to the ground point through a separate discharging path..

However, the initiating unit for keeping the charging level of the sensing electrodes to be always uniform is not necessarily configured using the discharging path as in the embodiments. For example, it is also possible to charge the sensing electrodes to always have a constant voltage by, for example, measuring the charge amount remained in the sensing electrode or its voltage and then suitably controlling the magnitude of the current applied to the sensing electrode or the time taken for applying the current.

As described above, the initiating unit of the present invention is not limited to the case of the second or third embodiment, but various means or methods may be adopted in order to accomplish the same function and results.

### INDUSTRIAL APPLICABILITY

The fingerprint sensing apparatus of the present invention may prevent DC current from being directly applied to the human body by installing a separate shielding unit between the sensing electrode and the current or voltage source.

Thus, it becomes possible to fundamentally eliminate the factors giving harmful influences on the human body and reduce unnecessary energy consumption in comparison to the prior one.

In addition, the fingerprint sensing apparatus of the present invention is capable of preventing the charging level of the sensing electrodes from being changed and always initiating the electrodes uniformly by installation of the shielding unit.

The present invention has been described in detail. However, it should be understood that the detailed description and specific examples, while indicating preferred embodiments of the invention, are given by way of illustration only, since various changes and modifications within the spirit and scope of the invention will become apparent to those skilled in the art from this detailed description.

1. A fingerprint sensing apparatus for generating successive analogue fingerprint signals reflecting a fingerprint impedance at each sensing point according to characteristics of a fingerprint in order to extract an inherent pattern of the fingerprint, the apparatus comprising:
a plurality of sensing electrodes arranged in matrix for contacting with a fingertip (or, ridges and valleys of the fingerprint);
means for supplying charges to the sensing electrodes; and
shielding means positioned between the sensing electrode and the charge supplying means for preventing DC current from being directly transferred to the fingertip through the sensing electrode.

2. A fingerprint sensing apparatus according to claim 1, wherein the shielding means is a charge accumulating element.

3. A fingerprint sensing apparatus according to claim 2, further comprising initiating means for keeping electric characteristic of the sensing electrodes uniformly in order to synchronize initial conditions for generating the fingerprint signals.

4. A fingerprint sensing apparatus according to claim 3,
wherein the initiating means is a discharging means for intentionally eliminating residual charges existing in the sensing electrodes and/or at both ends of the shielding means after the discharging of the sensing electrodes.

5. A fingerprint sensing apparatus according to claim 4, wherein the discharging means includes:
a discharging path for discharging the residual charges existing in the sensing electrodes and/or at both ends of the shielding means to a ground point; and
a switching element installed on the discharging path to switch on/off.

6. A fingerprint sensing apparatus according to claim 3,
wherein the initiating means is a means for charging the sensing electrodes uniformly on the basis of the residual charges existing in the sensing electrodes after the discharging of the sensing electrodes.

7. A fingerprint sensing apparatus for generating successive analogue fingerprint signals reflecting a fingerprint impedance at each sensing point according to characteristics of a fingerprint in order to extract an inherent pattern of the fingerprint, the apparatus comprising:
a plurality of sensing electrodes arranged in matrix for contacting with a fingertip (or, ridges and valleys of the fingerprint);
means for supplying charges to the sensing electrodes;
shielding means positioned between the sensing electrode and the charge supplying means for preventing DC current from being directly transferred to the fingertip through the sensing electrode; and
initiating means for keeping electric characteristic of the sensing electrodes uniformly in order to synchronize initial conditions for generating the fingerprint signals.

8. A fingerprint sensing apparatus according to claim 7,
wherein the initiating means is a discharging means for intentionally eliminating residual charges existing in the sensing electrodes and/or at both ends of the shielding means after the discharging of the sensing electrodes.

9. A fingerprint sensing apparatus according to claim 8, wherein the discharging means includes:
a discharging path for discharging the residual charges existing in the sensing electrodes and/or at both ends of the shielding means to a ground point; and
a switching element installed on the discharging path to switch on/off.

10. A fingerprint sensing apparatus according to claim 7,
wherein the initiating means is a means for charging the sensing electrodes uniformly on the basis of the residual charges existing in the sensing electrodes after the discharging of the sensing electrodes.
